(19) United States
(12) Patent Application Publication
(10) Pub. No.: US 2025/0232568 A1
(43) Pub. Date: Jul. 17, 2025

(54) PRESENTATION INFORMATION GENERATION APPARATUS AND PRESENTATION INFORMATION GENERATION METHOD

(71) Applicant: Panasonic Automotive Systems Co., Ltd., Kanagawa (JP)

(72) Inventors: Kazuya URAZOE, Osaka (JP); Taito SATO, Osaka (JP); Ryo ITO, Osaka (JP); Kyoko KAWAGUCHI, Tokyo (JP); Yoshiaki OWAKI, Osaka (JP)

(21) Appl. No.: 19/012,447

(22) Filed: Jan. 7, 2025

(30) Foreign Application Priority Data
Jan. 12, 2024 (JP) 2024-003452

(51) Int. Cl. G06V 10/774; G06V 10/764

(52) U.S. Cl. CPC G06V 10/774; G06V 10/764

(57) ABSTRACT

A presentation information generation apparatus includes: a data acquiring circuitry that acquires data from a sensor; a determining circuitry that determines an acquisition status of acquisition target data based on a comprehensive condition and the data acquired, the comprehensive condition being a condition related to the acquisition target data; and an information generating circuitry that generates presentation information corresponding to insufficient data among pieces of the acquisition target data for which the acquisition status is inadequate.

### CROSS REFERENCE TO RELATED APPLICATIONS

The disclosure of Japanese Patent Application No. 2024-003452 filed on Jan. 12, 2024 including the specification, drawings and abstract is incorporated herein by reference in its entirety.

### TECHNICAL FIELD

The present disclosure relates to a presentation information generation apparatus and a presentation information generation method.

### BACKGROUND ART

In recent years, various technologies have been proposed for collecting training data for machine learning in computers. For example, there are technologies that cameras are instructed to obtain images that meet certain conditions when the cameras sequentially captures images and the obtained images are used as training data (for example, Patent Literature (hereinafter, referred to as “PTL”) 1 to 3).

Capturing images for training data involves detailed instructions for each scene and multiple times of image capturing, which takes time. Although increasing the number of cameras can reduce the time required for image capturing, it is costly to increase the number of cameras.

In addition, a technology has been proposed that, based on the frequency of past data occurrences, displays the time until the collection of insufficient data is completed and continues data collection (for example, PTL 4).

Additionally, a technology has been proposed that extracts areas where accumulated survey data is lacking and sends requests for surveys of the extracted insufficient data to members” terminals (for example, PTL 5).

### CITATION LIST

### Patent Literature

### PTL 1

Japanese Patent Application Laid-Open No. 2022-058211

### PTL 2

Japanese Patent Application Laid-Open No. 2021-186456

### PTL 3

Japanese Patent Application Laid-Open No. 2020-064541

### PTL 4

Japanese Patent Application Laid-Open No. 2020-064406

### PTL 5

Japanese Patent Application Laid-Open No. 2012-118826

### Summary of Invention

Regarding training data for machine learning in computers, collection of a large amount of data corresponding to various situations is performed. For this purpose, efficient collection of training data has been studied.

The present disclosure contributes to providing a presentation information generation apparatus and a presentation information generation method that can efficiently collect training data.

A presentation information generation apparatus according to one exemplary embodiment of the present disclosure includes: a data acquiring circuitry which, in operation, acquires data from a sensor; a determining circuitry which, in operation, determines an acquisition status of acquisition target data based on a comprehensive condition and the data acquired, the comprehensive condition being a condition related to the acquisition target data; and an information generating circuitry which, in operation, generates presentation information corresponding to insufficient data among pieces of the acquisition target data for which the acquisition status is inadequate.

In addition, a presentation information generation method according to one exemplary embodiment of the present disclosure includes: acquiring data from a sensor; determining insufficient data among pieces of acquisition target data based on the data acquired and a comprehensive condition in which the pieces of acquisition target data are set, the insufficient data not satisfying the comprehensive condition; and; and generating presentation information corresponding to the insufficient data.

According to the present disclosure, training data can be efficiently collected.

### BRIEF DESCRIPTION OF DRAWINGS

FIG. 1 is a functional block diagram of a presentation information generation apparatus according to Embodiment 1;

FIG. 2 illustrates an example of comprehensive conditions;

FIG. 3 illustrates a determination result of categories of insufficient data;

FIG. 4 illustrates an example of image data captured by a camera;

FIG. 5 illustrates an example of metadata generated from image data;

FIG. 6 illustrates a determination result of the categories of insufficient data after new image data has been acquired;

FIG. 7 illustrates an example of presentation information presented by a presenter;

FIG. 8 illustrates an example of image data in which metadata has been generated;

FIG. 9 illustrates an example of presentation information presented by the presenter;

FIG. 10 illustrates another example of the comprehensive conditions;

FIG. 11 illustrates a determination result of the categories of insufficient data;

FIG. 12 illustrates an example of image data captured by a camera;

FIG. 13 illustrates an example of metadata generated from image data;

FIG. 14 illustrates a determination result of insufficient data categories after new image data has been acquired;

FIG. 15 illustrates an example of presentation information presented by the presenter;

FIG. 16 illustrates an example of image data in which metadata has been generated;

FIG. 17 illustrates an example of presentation information presented by the presenter;

FIG. 18 is a flowchart of a presentation information generation process;

FIG. 19 is a functional block diagram of a presentation information generation apparatus according to Embodiment 2;

FIG. 20 is a functional block diagram of a presentation information generation apparatus according to Embodiment 3;

FIG. 21 is a functional block diagram of a presentation information generation apparatus according to Embodiment 4;

FIG. 22 illustrates an example of an animation generated by an animation generating circuitry;

FIG. 23 is a functional block diagram of a presentation information generation apparatus according to Embodiment 5;

FIG. 24 illustrates an example of presentation information including metadata;

FIG. 25 is a functional block diagram of a presentation information generation apparatus according to Embodiment 6;

FIG. 26 illustrates an example of an image with table-formatted information indicating unacquired/acquired categories overlaid on a screen at the top right;

FIG. 27 is a functional block diagram of a presentation information generation apparatus according to Embodiment 7;

FIG. 28 is a functional block diagram of a presentation information generation apparatus according to Embodiment 8;

FIG. 29 is a functional block diagram of a presentation information generation apparatus according to Embodiment 9; and

FIG. 30 is a functional block diagram of a presentation information generation apparatus combining a plurality of embodiments.

### Description of Embodiments

Hereinafter, embodiments of the present disclosure will be described in detail with reference to the drawings. It should be noted that the embodiments described below are examples, and the present disclosure is not limited to these embodiments.

However, more detailed description than necessary may be omitted. For example, detailed descriptions of well-known matters and redundant descriptions of substantially the same configuration may be omitted. This is to avoid unnecessary redundancy of the following description and to facilitate understanding by a person skilled in the art.

### Embodiment 1

In following, Embodiment 1 of the present disclosure will be described.

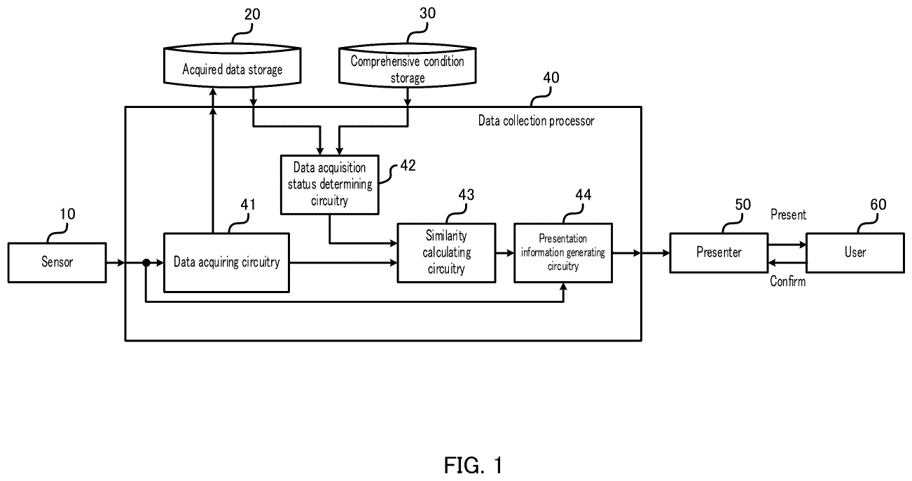

FIG. 1 is a functional block diagram of a presentation information generation apparatus according to Embodiment 1. This presentation information generation apparatus is an apparatus for collecting training data used in machine learning. For example, this presentation information generation apparatus collects, as training data, image data used in machine learning to estimate work content of workers in a factory so as to improve the work efficiency of the workers.

The presentation information generation apparatus includes sensor 10, acquired data storage 20, comprehensive condition storage 30, data collection processor 40, and presenter 50. data collection processor 40 includes data acquiring circuitry 41, data acquisition status determining circuitry 42, similarity calculating circuitry 43, and presentation information generating circuitry 44.

[symbol] data collection processor 40 includes a processor such as a CPU. Data acquiring circuitry 41, data acquisition status determining circuitry 42, similarity calculating circuitry 43, and presentation information generating circuitry 44 exist as functions of the CPU.

Sensor 10, acquired data storage 20, comprehensive condition storage 30, and presenter 50 may be integrated with data collection processor 40 or may be connected to data collection processor 40 by a communication means.

Sensor 10 acquires various types of data. Sensor 10 is, for example, a camera, microphone, laser, LIDAR, ultrasonic sensor, or a sensor that acquires temperature, humidity, wind speed, concentration of substances, etc. Hereinafter, a case where sensor 10 is a camera and the data acquired is image data will be described.

Sensor 10 may capture images at predetermined intervals or continuously. Sensor 10 outputs the image data of the captured images to data acquiring circuitry 41 and presentation information generating circuitry 44.

Acquired data storage 20 stores the image data acquired from sensor 10 up to the present as acquired data. In addition, acquired data storage 20 stores metadata generated based on the acquired data, in association with the acquired data. The metadata will be described in detail later.

Comprehensive condition storage 30 stores comprehensive conditions set for the categories of acquisition target image data. The comprehensive conditions specify what categories of image data is to be collected as training data, and set the collecting target number of pieces of image data for each category.

In addition, data acquiring circuitry 41 analyzes the image data acquired by sensor 10 to generate metadata containing feature quantity information corresponding to the category of the image data, for the purpose of using it as training data.

The categories of image data, for example, refer to categories resulting from dividing, into a plurality of ranges, the orientation and tilt of a worker's body contained in the image data in a factory. Data acquiring circuitry 41 generates metadata containing information on feature quantities corresponding to the categories such as the worker's skeletal information, body orientation, and tilt contained in the image data acquired by sensor 10.

Note that data acquiring circuitry 41 may generate metadata by extracting image data at predetermined intervals from the continuously captured image data by sensor 10, or it may generate metadata for part or all of the image data acquired by sensor 10 at predetermined intervals.

Data acquisition status determining circuitry 42 determines a category of insufficient image data (category for which the acquisition status is inadequate) based on the comprehensive conditions set for the categories of acquisition target image data and the information on the feature quantities of the image data acquired from sensor 10.

For example, data acquisition status determining circuitry 42 refers to the comprehensive conditions stored in comprehensive condition storage 30 to determine whether the number pieces of image data stored in the acquired data storage for each category has reached the collecting target number of pieces of training data set for each category in the comprehensive conditions.

Then, data acquisition status determining circuitry 42 determines, as lacking image data (insufficient data), the image data corresponding to the categories for which the collecting target number of pieces of training data have not been reached (categories where the acquisition status is insufficient).

Similarity calculating circuitry 43 determines whether the feature quantities of the image data (acquired data) obtained from sensor 10 are similar to the feature quantities of the image data included in the categories of insufficient data (categories where the acquisition status is insufficient), and outputs the determination result to presentation information generating circuitry 44. Note that similarity calculating circuitry 43 may omit outputting the determination result when it determines that the feature quantities of the image data currently being acquired by sensor 10 are not similar to a category of “lacking image data (insufficient data)” being a new acquisition target.

For example, similarity calculating circuitry 43 determines that the feature quantities of the image data obtained from sensor 10 and those of the category of the insufficient data are similar to each other when the orientation and tilt of the person in the image data obtained from sensor 10 are within a predetermined range of the orientation and tilt of the insufficient data.

In addition, similarity calculating circuitry 43 may determine that the feature quantities of the image data obtained from sensor 10 and those of the category of the insufficient data are similar to each other when the image data obtained from sensor 10 includes a person, and determine that they are not similar to each other when the image data acquired from sensor 10 does not include a person.

Presentation information generating circuitry 44 generates presentation information corresponding to the category of the insufficient data when similarity calculating circuitry 43 determines that the feature quantities of the image data obtained from sensor 10 and those of the category of the insufficient data are similar to each other, and outputs the generated presentation information to presenter 50.

For example, when the insufficient data is image data of a person facing 90 degrees to the right, presentation information generating circuitry 44 generates presentation information by overlaying the text “Please turn 90 degrees to the right” on the image data obtained by sensor 10. By presenting this presentation information to user 60, it is possible to make user 60 turn 90 degrees to the right, enabling the acquisition of the insufficient data.

The information overlaid on the image data is not limited to text information; it can also be pictograms or animations, as long as it is information that user 60 can visually recognize.

Presentation information generating circuitry 44 may not generate presentation information when similarity calculating circuitry 43 determines that the feature quantities of the image data obtained from sensor 10 and those of the category of the insufficient data are not similar to each other, or it may generate image data overlaid with pre-stored text information such as “No instructions”.

Presenter 50 presents the presentation information generated by presentation information generating circuitry 44 to user 60. Presenter 50 is, for example, an output unit such as a display or speaker. Then, user 60 adjusts their body orientation, etc., to acquire the insufficient data while checking the information presented by presenter 50.

Note that there may be more than one presenter 50. In addition, presenter 50 is not limited to the display but may also be devices such as AR (Augmented Reality) glasses that enable three-dimensional visualization.

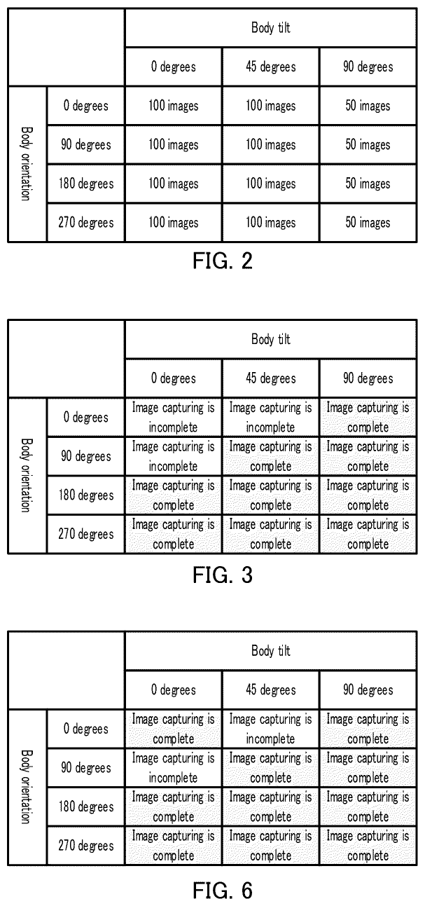

FIG. 2 illustrates an example of comprehensive conditions. The comprehensive conditions include four categories of body orientation (0 degrees, 90 degrees, 180 degrees, and 270 degrees) and three categories of body tilt (0 degrees, 45 degrees, and 90 degrees) as conditions for the acquisition target data.

Then, regardless of the body orientation, the collecting target number of pieces of image data is set to 100 for body tilts of 0 degrees and 45 degrees, and 50 for a body tilt of 90 degrees. Since the frequency of the body being tilted at 90 degrees is not very high, the number of pieces of training data is set to be low.

FIG. 3 illustrates the results of determining the categories of insufficient data (categories where the acquisition status is insufficient). In the example of FIG. 3, it is shown that image data with a body orientation of 0 degrees and a body tilt of 0 degrees, image data with a body orientation of 0 degrees and a body tilt of 45 degrees, and image data with a body orientation of 90 degrees and a body tilt of 0 degrees are insufficient as teacher data and that image capturing is incomplete.

In the example of FIG. 3, although data acquisition status determining circuitry 42 determines whether the image capturing is “image capturing is complete” or “image capturing is incomplete”, it may determine not that “image capturing is incomplete” but how much image data is lacking, for example, “32 more items needed”. Note that “image capturing is complete” may be referred to as sufficient data, and “image capturing is incomplete” may be referred to as insufficient data.

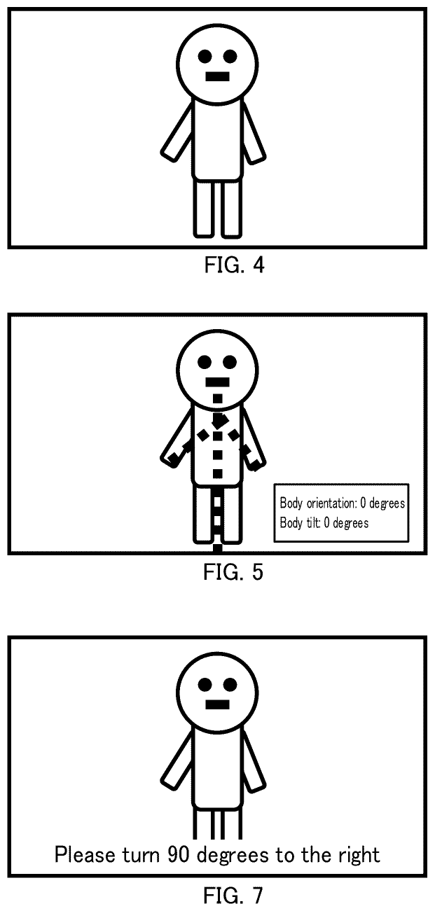

FIG. 4 illustrates an example of image data captured by a camera. FIG. 5 illustrates an example of metadata generated from image data. Data acquiring circuitry 41 analyzes the person in the image data of FIG. 4 and generates, as metadata, skeletal information (dotted line in FIG. 5), information on a body orientation of 0 degrees, and information on a body tilt of 0 degrees. Note that while here the metadata includes skeletal information, body orientation information, and body tilt information, other information may also be included.

Then, the image data shown in FIG. 4 and the metadata generated by data acquiring circuitry 41 are stored in acquired data storage 20.

FIG. 6 illustrates the determination results of the categories of insufficient data after new image data has been acquired. FIG. 6 shows the situation where, in the state shown in FIG. 3, the image data shown in FIG. 4 was captured and registered along with the metadata, resulting in the image data with a body orientation of 0 degrees and a body tilt of 0 degrees meeting the collecting target number specified by the comprehensive conditions, thereby changing the image capturing status to “image capturing is complete”.

Subsequently, when the orientation and tilt of the person's body in the image data acquired by sensor 10 are within certain ranges from 90 degrees and 0 degrees, respectively, it is determined that image data for the category of a body orientation of 90 degrees and a body tilt of 0 degrees is “insufficient data” being a new acquisition target.

Then, presentation information such as “Please turn 90 degrees to the right” or “Please assume a posture with a body orientation of 90 degrees and a body tilt of 0 degrees” is generated.

FIG. 7 illustrates an example of the presentation information presented by presenter 50. Presenter 50 presents the presentation information “Please turn 90 degrees to the right” generated by presentation information generating circuitry 44.

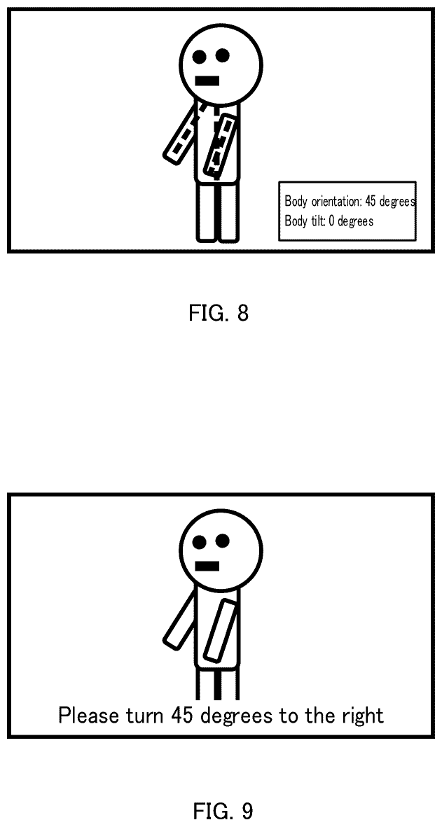

FIG. 8 illustrates an example of image data for which metadata has been generated. FIG. 8 shows image data captured when the subject (user 60) changed the orientation of their body to a 45-degree right turn from the state shown in FIG. 4. Data acquiring circuitry 41, similarity calculating circuitry 43, and presentation information generating circuitry 44 perform the same process as when the image data of FIG. 4 was captured, generating presentation information such as “Please turn 45 degrees to the right”, for example.

FIG. 9 illustrates an example of the presentation information presented by presenter 50. The presentation information includes the text information “Please turn 45 degrees to the right”. By the subject following this presentation information and further changing the orientation of their body by 45 degrees, it is possible to acquire the image data with a body orientation of 90 degrees and a body tilt of 0 degrees that is insufficient for teacher data.

Although the description has been given of the case where image data is collected as teacher data for estimating the work content of workers, the technique disclosed here can be applied to the collection of teacher data used for learning, whether it be other types of image data or even non-image teacher data.

Hereinafter, as an example of other teacher data, a case will be described where image data used for machine learning to estimate the presence of a person to avoid collisions between vehicles and people is collected.

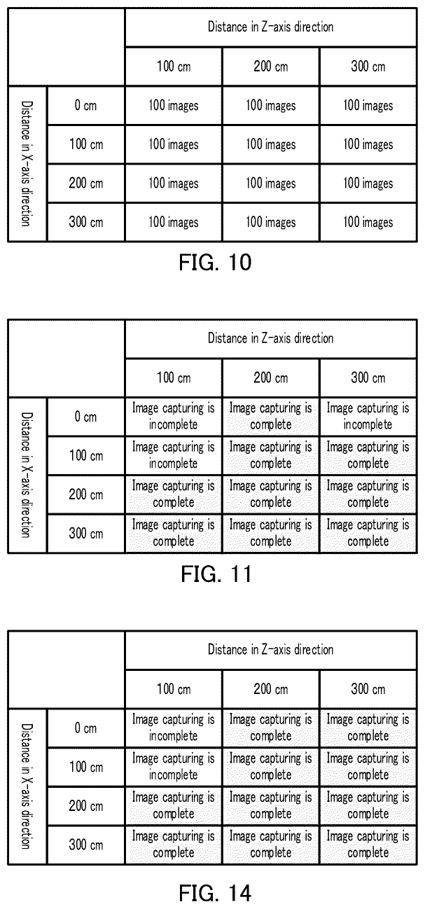

FIG. 10 illustrates another example of comprehensive conditions. These comprehensive conditions include categories based on the distance to a person. Specifically, the comprehensive conditions include four categories of distances in the X-axis direction: 0 cm, 100 cm, 200 cm, and 300 cm, and three categories of distances in the Z-axis direction: 100 cm, 200 cm, and 300 cm.

Then, for each combination of the X-direction distance category and the Z-direction distance category, the collecting target number of pieces of image data is set to 100.

FIG. 11 illustrates a determination result of the categories of insufficient data. In the example of FIG. 11, it is shown that image data with a distance of 0 cm in the X-axis direction and 100 cm in the Z-axis direction, image data with a distance of 100 cm in both the X-axis and Z-axis directions, and image data with a distance of 0 cm in the X-axis direction and 300 cm in the Z-axis direction are insufficient for teacher data and image capturing has not been completed.

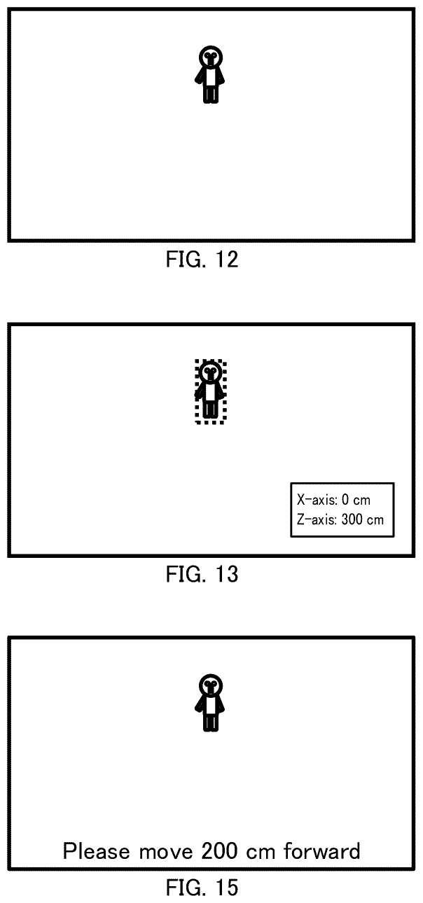

FIG. 12 illustrates an example of image data captured by a camera. FIG. 13 illustrates an example of metadata generated from image data. Data acquiring circuitry 41 analyzes the person in the image data of FIG. 12 and generates as metadata the feature quantities of the image data, such as information on the distance of 0 cm in the X-axis direction and the distance of 300 cm in the Z-axis direction.

Note that the metadata may include other information. Alternatively, distance data measured by a distance sensor may be set as the metadata of the image data instead of the metadata generated by data acquiring circuitry 41.

The image data shown in FIG. 13 and the metadata generated by data acquiring circuitry 41 are stored in acquired data storage 20.

FIG. 14 illustrates a determination result of the categories of insufficient data after new image data has been acquired. FIG. 14 shows the situation where, in the state shown in FIG. 11, the image data shown in FIG. 12 was captured and registered along with its metadata, resulting in the image data with a distance of 0 cm in the X-axis direction and 300 cm in the Z-axis direction meeting the collecting target number specified by the comprehensive conditions, thus changing the status of the image capturing to “image capturing is complete”.

Subsequently, when the distance in the X-axis direction and the distance in the Z-axis direction to the person contained in the image data acquired by sensor 10 are within certain ranges from 0 cm and 100 cm, respectively, image data for the category with a distance of 0 cm in the X-axis direction and 100 cm in the Z-axis direction is determined to be “insufficient data”. Then, presentation information saying “Please move 200 cm forward” is generated.

FIG. 15 illustrates an example of the presentation information presented by presenter 50. The presentation information includes the text information “Please move 200 cm forward”.

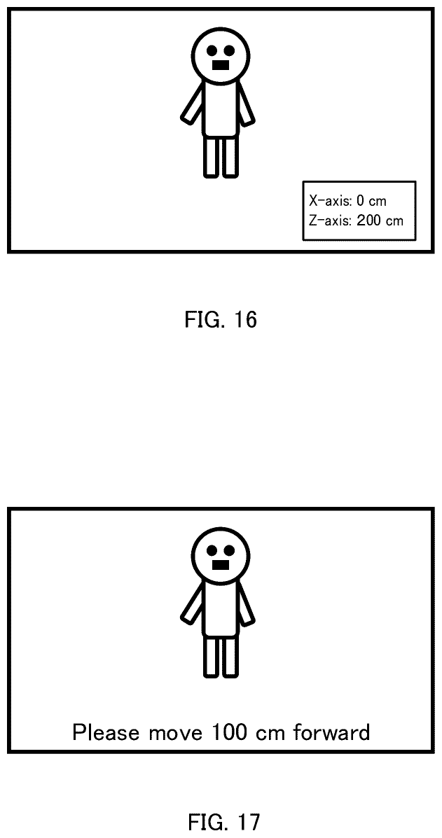

FIG. 16 illustrates an example of image data for which metadata has been generated. FIG. 16 shows the state in which the subject (user 60) has moved forward in accordance with the presentation information presented by presenter 50, and data acquiring circuitry 41 has generated metadata for the image data captured by the camera.

Specifically, FIG. 16 shows image data of the state where the subject has moved 100 cm forward from the state in FIG. 15, and the distance in the Z-axis direction has become 200 cm. In this case, data acquiring circuitry 41, similarity calculating circuitry 43, and presentation information generating circuitry 44 perform the same process as when the image data in FIG. 12 was captured, and generate presentation information such as “Please move 100 cm forward”.

FIG. 17 illustrates an example of the presentation information presented by presenter 50. By moving forward in accordance with the presentation information presented by presenter 50, the subject (user 60) can acquire image data with a distance of 0 cm in the X-axis direction and 100 cm in the Z-axis direction, which is missing as training data.

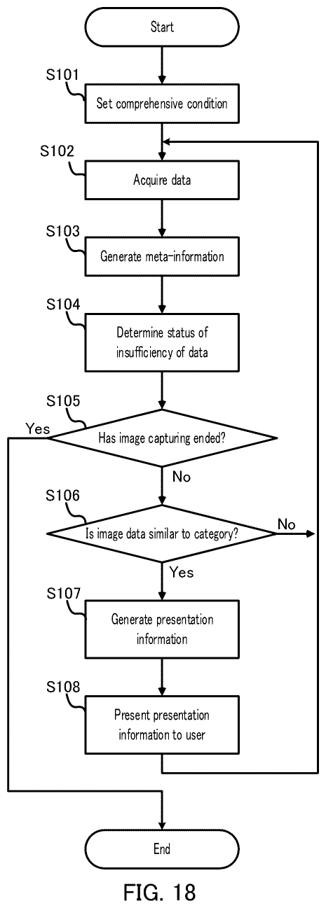

FIG. 18 illustrates a flowchart of the process for generating presentation information.

Data collection processor 40 accepts the setting of comprehensive conditions through an input unit not shown, and stores those comprehensive conditions in comprehensive condition storage 30 (step S101). In the comprehensive conditions, how much the image data belonging to each category is to be acquired is set, and the comprehensive conditions are set by designers of machine learning, etc.

Subsequently, once the comprehensive conditions are set, data acquiring circuitry 41 acquires data from sensor 10 (step S102). For example, when sensor 10 is a camera, data acquiring circuitry 41 acquires image data.

Thereafter, data acquiring circuitry 41 generates metadata for the image data acquired from sensor 10, and stores the image data and metadata in association with each other in acquired data storage 20 (step S103).

It should be noted that data acquired by sensors other than the camera may also be treated as metadata. For example, the distance acquired by a distance sensor may be treated as metadata for the image data.

Then, data acquisition status determining circuitry 42 refers to the comprehensive conditions to determine whether the number of pieces of image data stored in the acquired data for each category is insufficient (step S104). The result of this determination may be indicated as “complete” or “incomplete”, or by the number of missing image data.

In addition, data acquisition status determining circuitry 42 determines whether to end the image capturing (step S105). When data acquisition status determining circuitry 42 determines that the necessary numbers of pieces of image data for all categories have been acquired, it ends the image capturing by sensor 10 (step S105, Yes).

When data acquisition status determining circuitry 42 determines that the necessary numbers of pieces of image data for all categories have not been acquired, it proceeds to the process of step S106 (step S105, No).

Next, similarity calculating circuitry 43 determines whether the feature quantities of the image data acquired from sensor 10 are similar to those of the category of insufficient data (step S106).

When it is determined that the feature quantities of the image data are not similar to those of the category of insufficient data (step S106, No), the process returns to step S102, and data acquiring circuitry 41 acquires the next image data from sensor 10.

When it is determined that the feature quantities of the image data and the category of insufficient data are similar to each other (step S106, Yes), presentation information corresponding to the category of insufficient data is generated and the generated presentation information is output to presenter 50 (step S107).

The presentation information generated by presentation information generating circuitry 44 is, for example, text information such as “Please turn 45 degrees to the right.”

Then, presenter 50 presents the presentation information generated by presentation information generating circuitry 44 to user 60 (step S108).

Then, the apparatus returns to step S102, and data acquiring circuitry 41 acquires the next image data from sensor 10. Data acquiring circuitry 41 may acquire image data from sensor 10 after a predetermined time elapses after the presentation information is presented in step S108.

The image data acquired in step S102 is the image data after user 60 has moved their body according to the presentation information presented to user 60 in step S108, therefore, it is expected to acquire the insufficient data determined by data acquisition status determining circuitry 42.

As described above, the presentation information generation apparatus of Embodiment 1 can efficiently collect image data that is difficult to collect due to its low occurrence frequency.

### Embodiment 2

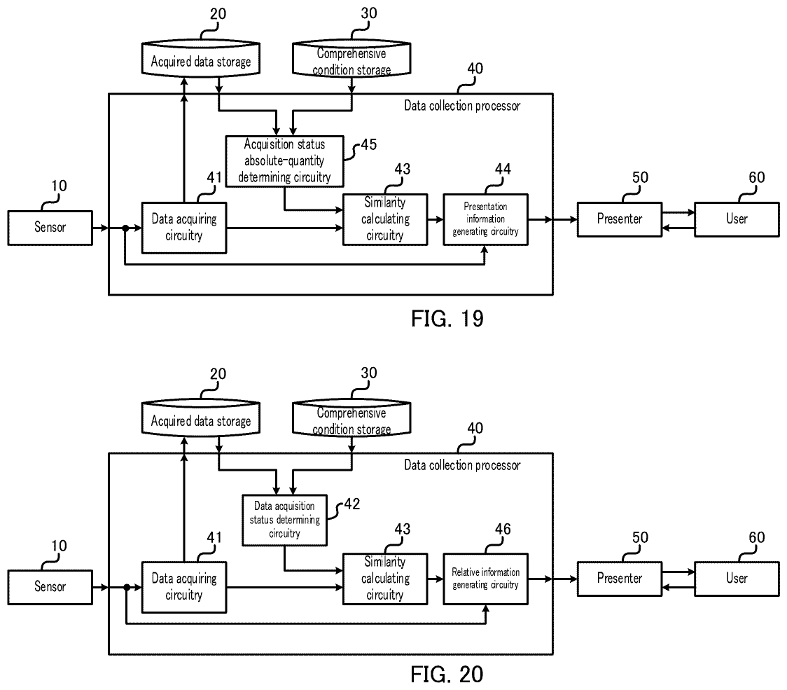

FIG. 19 is a functional block diagram of the presentation information generation apparatus according to Embodiment 2.

This presentation information generation apparatus has acquisition status absolute-quantity determining circuitry 45 instead of data acquisition status determining circuitry 42 in Embodiment 1. The functions of the other functional sections are the same as those in Embodiment 1.

Acquisition status absolute-quantity determining circuitry 45 determines the category of insufficient data based on the comprehensive conditions set for the categories of acquisition target image data and the feature quantities of the image data acquired from sensor 10, like data acquisition status determining circuitry 42.

However, acquisition status absolute-quantity determining circuitry 45 determines the image data that is a target for prioritized acquisition among pieces of insufficient data. Then, presentation information generating circuitry 44 generates presentation information from the image data that is the target for prioritized acquisition.

For example, acquisition status absolute-quantity determining circuitry 45 records the occurrence frequency of image data for each category as log information and preferentially selects the category with a lower occurrence frequency of image data as a new target category for acquiring image data.

Then, when similarity calculating circuitry 43 determines that the feature quantities of the image data currently being acquired by sensor 10 are similar to those of the category of the new target image data, presentation information generating circuitry 44 generates presentation information corresponding to the category of insufficient data and outputs the generated presentation information to presenter 50.

By presenting such presentation information to user 60 and prompting an action of the user, it is possible to efficiently collect the set number of pieces of image data in each category.

Note that acquisition status absolute-quantity determining circuitry 45 may preferentially select the category with a higher occurrence frequency of image data as a new target category for acquiring image data. Also, acquisition status absolute-quantity determining circuitry 45 may refer to the comprehensive conditions and select the image data with a higher collecting target number as the target for prioritized acquisition.

In addition, acquisition status absolute-quantity determining circuitry 45 may select, as the prioritized acquisition target image data, the smallest number of pieces of insufficient image data based on the collecting target number set for each category in the comprehensive conditions and the feature quantities of the image data acquired from sensor 10.

Additionally, acquisition status absolute-quantity determining circuitry 45 may take into account the time when the image data acquired from sensor 10 was captured. For example, when the category of image data includes a time category and there is a shortage of image data for a nighttime category, nighttime image data may be selected as the image data to be preferentially acquired.

In this case, presentation information generating circuitry 44 may generate presentation information such as “Please create a nighttime environment,” “A nighttime environment has been created. Please move 200 cm forward.”

Alternatively, categories of image data to be collected preferentially may be defined manually in advance, and image data for those categories may be selected to be acquired preferentially. The categories of image data to be collected preferentially may be appropriately defined by considering by a person, based on empirical rules, whether a greater or lesser absolute quantity is preferable.

### Embodiment 3

FIG. 20 is a functional block diagram of the presentation information generation apparatus according to Embodiment 3.

Embodiment 3 includes relative information generating circuitry 46 instead of presentation information generating circuitry 44 in Embodiment 1. The functions of the other sections are the same as those in Embodiment 1.

Relative information generating circuitry 46 generates presentation information corresponding to the categories of insufficient data from sensor 10, like presentation information generating circuitry 44.

Relative information generating circuitry 46 generates, as presentation information, information indicating actions (state differences) for transition from the current state to the state of insufficient data. Therefore, the subject (user 60) can easily recognize what to do with the current situation.

For example, relative information generating circuitry 46 may generate presentation information such as “Please turn 90 degrees to the right” and “Please move 100 cm forward” based on the information indicating the action (difference).

### Embodiment 4

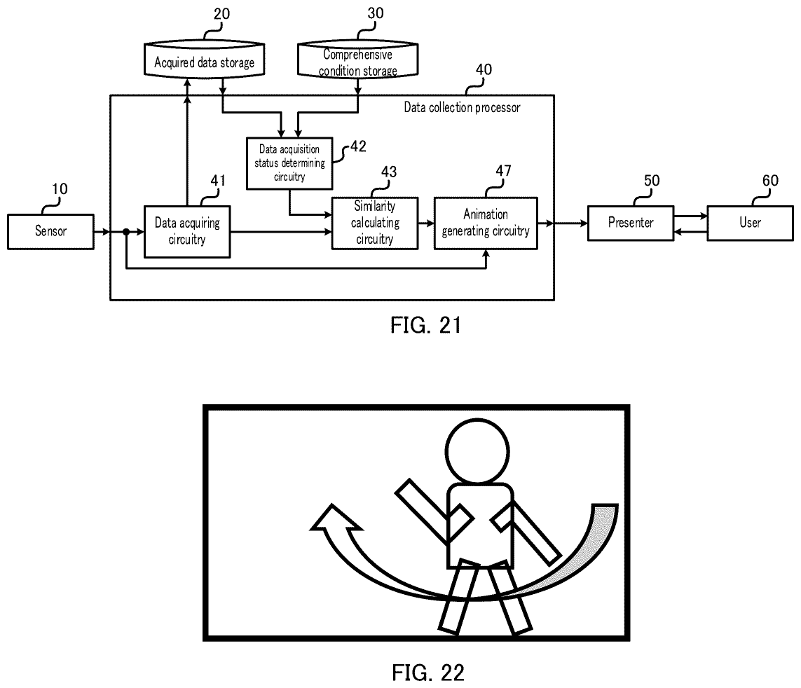

FIG. 21 is a functional block diagram of the presentation information generation apparatus according to Embodiment 4.

Embodiment 4 includes animation generating circuitry 47 instead of presentation information generating circuitry 44 in Embodiment 1. The functions of the other sections are the same as those in Embodiment 1.

Animation generating circuitry 47 generates presentation information corresponding to the categories of insufficient data from sensor 10, like presentation information generating circuitry 44.

However, animation generating circuitry 47 generates a video (animation) or a still image as presentation information, showing the transition from the current state to the state of insufficient data.

FIG. 22 illustrates an example of an animation generated by animation generating circuitry 47. For example, as presentation information for acquiring image data where the body orientation is 90 degrees and the body tilt is 0 degrees in the state of FIG. 4, animation generating circuitry 47 generates a video showing a 90-degree rotation of the body orientation, as shown in FIG. 22. By performing actions according to the animation presented on presenter 50, the user can acquire the insufficient data.

In addition, as presentation information, when a still image showing the transition from the current state to the state of insufficient data is generated, the transition is represented by, for example, an arrow.

### Embodiment 5

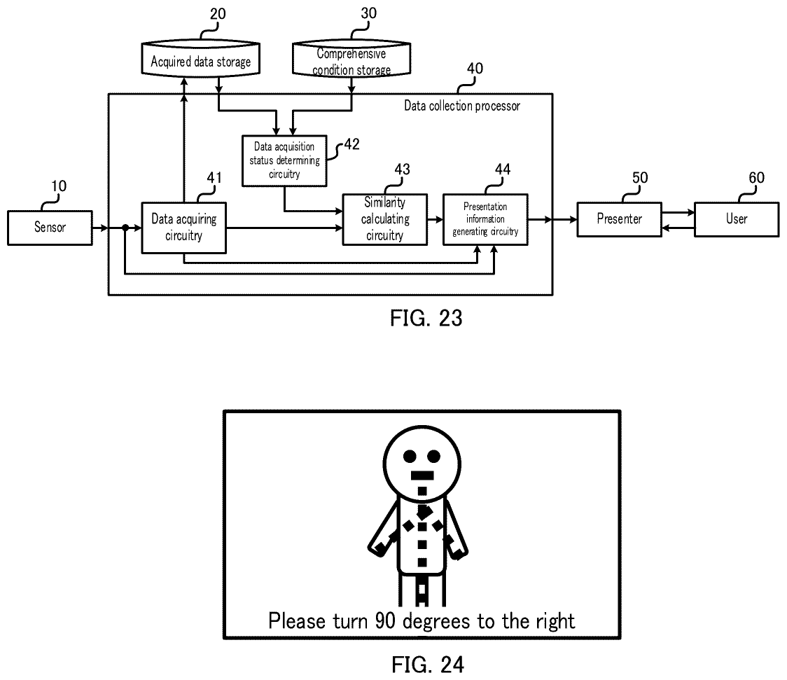

FIG. 23 is a functional block diagram of the presentation information generation apparatus according to Embodiment 5.

In Embodiment 5, data acquiring circuitry 41 from Embodiment 1 outputs metadata to presentation information generating circuitry 44. Then, presentation information generating circuitry 44 generates information including metadata as presentation information to be presented to user 60. Then presenter 50 presents the presentation information including the metadata. The functions of the other functional sections are the same as those in Embodiment 1.

FIG. 24 illustrates an example of presentation information including metadata. The presentation information in FIG. 24 includes textual information saying “Please turn 90 degrees to the right,” along with skeletal information, which is a type of metadata. Thus, user 60 can easily check the current state, and the presentation information generation apparatus can efficiently acquire insufficient data.

### Embodiment 6

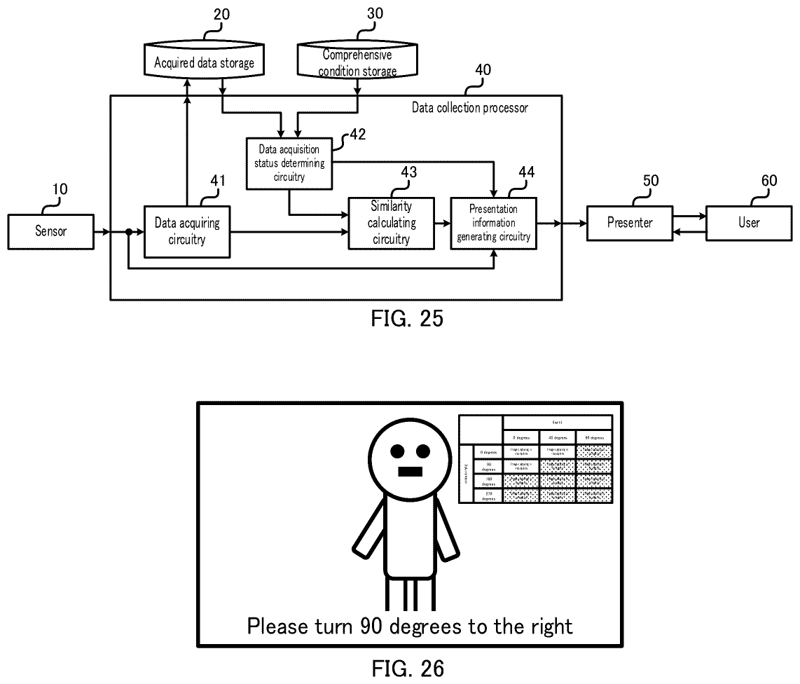

FIG. 25 is a functional block diagram of the presentation information generation apparatus according to Embodiment 6.

In Embodiment 6, data acquisition status determining circuitry 42 determines the categories of acquired image data (sufficient data) and insufficient data (insufficient data) based on the feature quantities of image data stored in acquired data storage 20 and the comprehensive conditions stored in comprehensive condition storage 30, and outputs the results to presentation information generating circuitry 44.

For example, data acquisition status determining circuitry 42 outputs to presentation information generating circuitry 44 information indicating determination results as shown in FIG. 3.

Then, presentation information generating circuitry 44 generates information including a determination result of the categories of acquired image data and insufficient data as presentation information. Then, presenter 50 presents the presentation information. The functions of the other functional sections are the same as those in Embodiment 1.

For example, when presentation information including determination results as shown in FIG. 3 is presented, it can make the user aware of what state is being requested since these determination results can be represented in a table format with two states (variables).

In addition, when the categories of image data are represented by three or more states (variables), the two states used for information expressed in the table format may be selected from the three or more states, and the selected states may be those that are of interest or representative states.

FIG. 26 illustrates an example of an image with table format information indicating the unacquired/acquired categories overlaid on the top right of the screen.

Thus, by presenting which categories are missing, user 60 can recognize the categories to be targeted for image data acquisition, allowing user 60 to act quickly to achieve the state of insufficient data.

### Embodiment 7

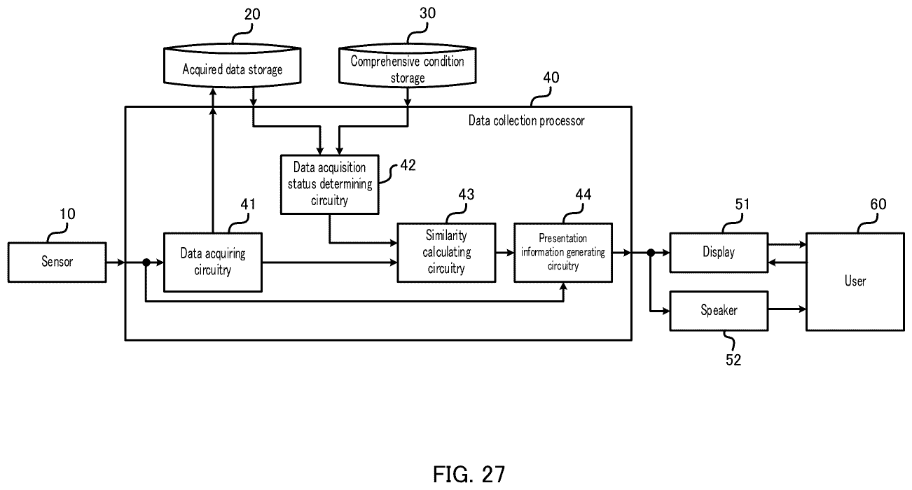

FIG. 27 is a functional block diagram of the presentation information generation apparatus according to Embodiment 7.

Embodiment 7 includes display 51 and speaker 52 as the presenter. Note that display 51 does not have to be provided. Presentation information generating circuitry 44 generates audio information along with display information as presentation information. The audio information generated by presentation information generating circuitry 44 is output to user 60 by speaker 52. The functions of the other functional sections are the same as those in Embodiment 1.

For example, when presentation information generating circuitry 44 generates presentation information as an image shown in FIG. 7, it also generates audio information output by speaker 52, such as “Please turn 90 degrees to the right.”

In the case of presentation information such as “Please turn around,” it may be difficult for user 60 to check the presentation information displayed on display 51 when acting based on the presentation information, but by outputting the presentation information through speaker 52 in audio form, it becomes easier for user 60 to continue recognizing the presentation information.

### Embodiment 8

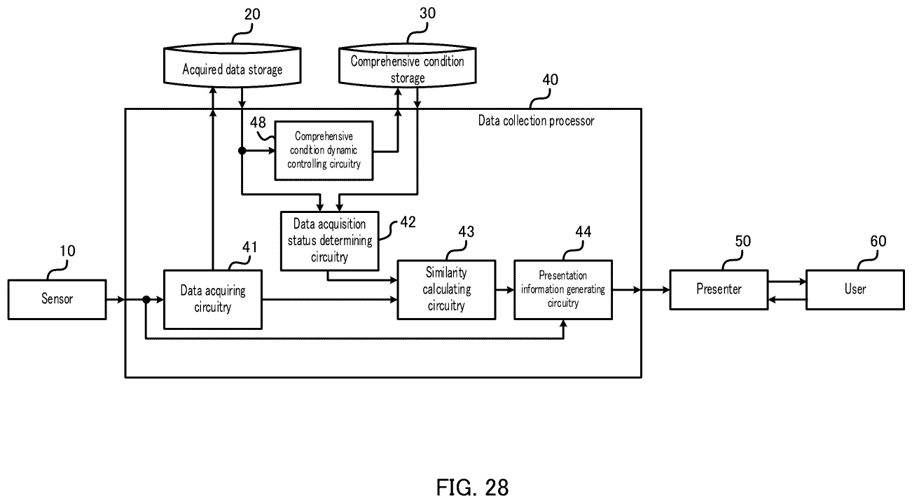

FIG. 28 is a functional block diagram of a presentation information generation apparatus according to Embodiment 8.

In Embodiment 8, comprehensive condition dynamic controlling circuitry 48 changes the comprehensive conditions based on the data stored in acquired data storage 20. Comprehensive condition dynamic controlling circuitry 48 may consider the data currently being acquired by sensor 10 for changing the comprehensive conditions. The functions of the other functional sections are the same as those in Embodiment 1.

Comprehensive condition dynamic controlling circuitry 48 changes the comprehensive conditions every time a predetermined number of pieces of image data are newly accumulated in acquired data storage 20. For example, when comprehensive condition dynamic controlling circuitry 48 determines that the number of pieces of accumulated image data for a specific category is low as acquired data, it changes the category of the image data with a small accumulation number.

For example, assume that the orientation of the body is set in four categories: 0 degrees, 90 degrees, 180 degrees, and 270 degrees.

In this situation, it is assumed that as a result of analysis on the metadata of the image data accumulated in acquired data storage 20, comprehensive condition dynamic controlling circuitry 48 determines that among pieces of the image data in the range of from −45 degrees to 45 degrees included in the 0 degrees category of the comprehensive conditions, pieces of the image data from 0 degrees to 45 degrees are heavily accumulated, but pieces of the image data from −45 degrees to 0 degrees are not much accumulated. In addition, due to this imbalance, the accuracy of inference using the trained model may not improve.

In this case, comprehensive condition dynamic controlling circuitry 48 sets the comprehensive conditions to include the −22.5 degrees category corresponding to the image data from −45 degrees to 0 degrees, and the 22.5 degrees category corresponding to the image data from 0 degrees to 45 degrees.

Then, the −22.5 degrees category, having less accumulated image data, will be “image capturing is incomplete,” and the 22.5 degrees category, with more accumulated image data, will be “image capturing is complete.”

Thus, by changing the categories of comprehensive conditions, it is possible to set the categories more appropriately and efficiently collect the image data belonging to those categories.

Note that comprehensive condition dynamic controlling circuitry 48 may be located outside data collection processor 40.

### Embodiment 9

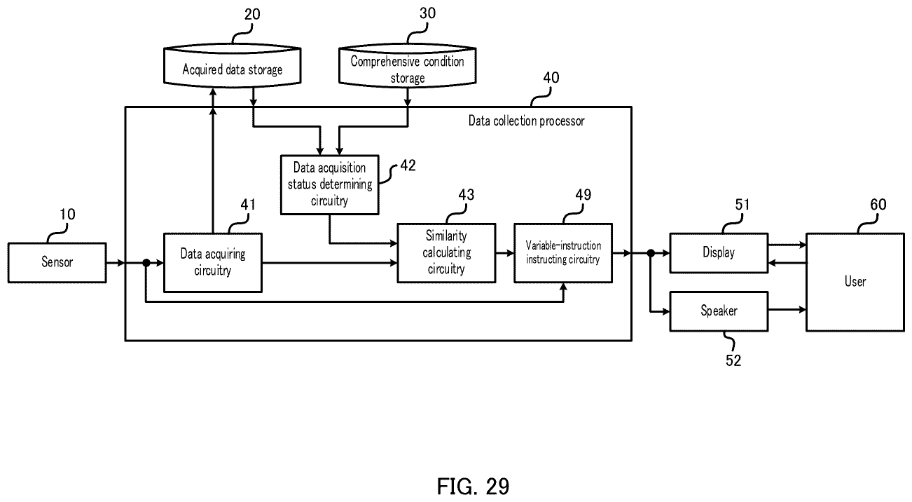

FIG. 29 is a functional block diagram of a presentation information generation apparatus according to Embodiment 9.

Embodiment 9 has variable-instruction instructing circuitry 49 instead of presentation information generating circuitry 44 in Embodiment 1. The functions of the other functional sections are the same as those in Embodiment 1.

Variable-instruction instructing circuitry 49, like presentation information generating circuitry 44, generates presentation information corresponding to the category of insufficient data from sensor 10.

However, variable-instruction instructing circuitry 49 generates, as the presentation information, information with different presentation modes depending on the content to be presented.

For example, variable-instruction instructing circuitry 49 changes the presentation modes of the presentation information between a case where the presentation information of “Please turn 45 degrees to the right” is generated and a case where the presentation information of “Please turn 135 degrees to the right” is generated.

Specifically, when variable-instruction instructing circuitry 49 displays the presentation information “Please turn 45 degrees to the right” on display 51, it generates presentation information that is displayed with rapid blinking or in red text, and when the presentation information is output from speaker 52, variable-instruction instructing circuitry 49 generates the presentation information of a voice output at shortened output intervals or a high-pitched sound “beep beep beep” output at short intervals.

On the other hand, when variable-instruction instructing circuitry 49 displays the information “Please turn 135 degrees to the right” on display 51, it generates the presentation information that is displayed with slow blinking or in blue text, and when the presentation information is output from speaker 52, variable-instruction instructing circuitry 49 generates the presentation information of a voice output at elongated output intervals or a low-pitched sound “beep, beep, beep” output at long intervals.

In addition, variable-instruction instructing circuitry 49 may change the form of presentation generated based on a similarity output by similarity calculating circuitry 43.

For example, when similarity calculating circuitry 43 determines that the feature quantities of the image data acquired from sensor 10 are similar to those of the category of insufficient data, variable-instruction instructing circuitry 49 generates presentation information displayed in red text and generates presentation information of a sound output at short intervals (or high-pitched sound).

On the other hand, when similarity calculating circuitry 43 determines that the feature quantities of the image data acquired from sensor 10 are not similar to those the category of insufficient data, variable-instruction instructing circuitry 49 generates presentation information displayed in blue text and generates presentation information of a sound output at long intervals (or low-pitched sound).

### Combination of Embodiments

It should be noted that the multiple embodiments described above can be combined.

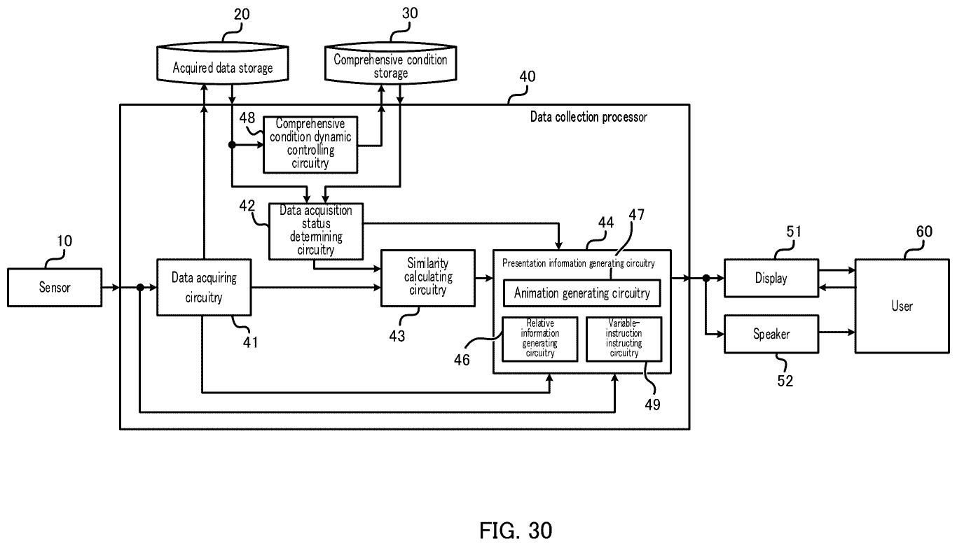

FIG. 30 is a functional block diagram of a presentation information generation apparatus in which a plurality of embodiments is combined. In this example, presentation information generating circuitry 44 includes relative information generating circuitry 46, animation generating circuitry 47, and variable-instruction instructing circuitry 49.

In this case, for example, relative information generating circuitry 46 generates information that shows the difference between the state of insufficient data and the current state as presentation information. Then, animation generating circuitry 47 generates a video (animation) or a still image that shows the transition from the current state to the state of insufficient data, based on the information indicating the difference between the two states.

In addition, variable-instruction instructing circuitry 49 generates presentation information with different presentation modes depending on the category of the image data. Then, display 51 or speaker 52 presents the presentation information to user 60 in different presentation modes depending on the category of insufficient data from sensor 10. The functions of the other components are the same as those in Embodiment 1.

For example, animation generating circuitry 47 and variable-instruction instructing circuitry 49 may generate an animation of a character with a low voice (male voice) wearing blue clothes when generating presentation information that prompts user 60 to turn right, and may generate an animation of a character with a high voice (female voice) wearing red clothes when generating presentation information that prompts turning left.

In addition, in addition to animations, presentation information generating circuitry 44 may generate presentation information that displays in table format the information including a determination result of the categories of acquired image data and the categories of insufficient data, and comprehensive condition dynamic controlling circuitry 48 may further perform dynamic changes to the comprehensive conditions.

The expressions “ . . . processor”, “ . . . -er”, “ . . . -or”, and “ . . . ar” in each embodiment described above may be replaced with other expressions such as “ . . . circuitry”, “ . . . assembly”, “ . . . device”, “ . . . unit”, or “ . . . module”.

Although the embodiments have been described above with reference to the drawings, the present disclosure is not limited to these examples. Obviously, a person skilled in the art would arrive at variations and modifications within a scope described in claims. It is understood that these variations and modifications are within the technical scope of the present disclosure. Moreover, any combination of features of the above-mentioned embodiments may be made without departing from the spirit of the disclosure.

(1) A presentation information generation apparatus according to one exemplary embodiment of the present disclosure includes: a data acquiring circuitry which, in operation, acquires data from a sensor; a determiing circuitry which, in operation, determines an acquisition status of acquisition target data based on a comprehensive condition and the data acquired, the comprehensive condition being a condition related to the acquisition target data; and an information generating circuitry which, in operation, generates presentation information corresponding to insufficient data among pieces of the acquisition target data for which the acquisition status is inadequate.

(2) A presentation information generation apparatus according to one exemplary embodiment of the present disclosure is the presentation information generation apparatus in (1), further including a similarity calculating circuitry which, in operation, determines whether the acquired data and the insufficient data are similar to each other, in which the information generating circuitry generates the presentation information when the acquired data and the insufficient data are similar to each other.

(3) A presentation information generation apparatus according to one exemplary embodiment of the present disclosure is the presentation information generation apparatus in (1), in which the data acquiring circuitry generates metadata that includes information on a feature quantity of the acquired data and associates the metadata with the acquired data.

(4) A presentation information generation apparatus according to one exemplary embodiment of the present disclosure is the presentation information generation apparatus in (1), in which the comprehensive condition includes a category for classifying the acquisition target data and an acquisition target number for each category, and the determining circuitry determines, as the insufficient data, a category for which the acquisition target number is not reached.

(5) A presentation information generation apparatus according to one exemplary embodiment of the present disclosure is the presentation information generation apparatus in (1), in which the determining circuitry determines prioritized data, which is a target for prioritized acquisition, from among pieces of the insufficient data, and the information generating circuitry preferentially generates the presentation information for the prioritized data.

(6) A presentation information generation apparatus according to one exemplary embodiment of the present disclosure is the presentation information generation apparatus in (1), in which the information generating circuitry generates, as the presentation information, information indicating an action for transition from the acquired data to the insufficient data.

(7) A presentation information generation apparatus according to one exemplary embodiment of the present disclosure is the presentation information generation apparatus in (1), in which the acquired data is an image, and the information generating circuitry generates, as the presentation information, a video or still image showing transition from the acquired data to the insufficient data.

(8) A presentation information generation apparatus according to one exemplary embodiment of the present disclosure is the presentation information generation apparatus in (3), in which the information generating circuitry generates, as the presentation information, information including the metadata.

(9) A presentation information generation apparatus according to one exemplary embodiment of the present disclosure is the presentation information generation apparatus in (1), in which the information generating circuitry further generates the presentation information corresponding to sufficient data among the pieces of acquisition target data for which the acquisition status is adequate.

(10) A presentation information generation apparatus according to one exemplary embodiment of the present disclosure is the presentation information generation apparatus in (1), in which the information generating circuitry generates, as the presentation information, information including audio information.

(11) A presentation information generation apparatus according to one exemplary embodiment of the present disclosure is the presentation information generation apparatus in (1), further including a controlling circuitry which, in operation, changes the comprehensive condition based on the acquired data.

(12) A presentation information generation apparatus according to one exemplary embodiment of the present disclosure is the presentation information generation apparatus in (1), in which the information generating circuitry generates, as the presentation information, information for which a presentation mode differs depending on a content to be presented.

(13) A presentation information generation method according to one exemplary embodiment of the present disclosure includes: acquiring data from a sensor; determining insufficient data among pieces of acquisition target data based on the data acquired and a comprehensive condition in which the pieces of acquisition target data are set, the insufficient data not satisfying the comprehensive condition; and generating presentation information corresponding to the insufficient data.

(14) A presentation information generation method according to one exemplary embodiment of the present disclosure is the presentation information generation method in (13), further including generating the presentation information when the acquired data and the insufficient data are similar to each other.

(15) A presentation information generation method according to one exemplary embodiment of the present disclosure is the presentation information generation method in (13), further including generating, based on the acquired data, metadata that includes information on a feature quantity of the acquired data and storing the metadata in a storage in association with the acquired data.

(16) A presentation information generation method according to one exemplary embodiment of the present disclosure is the presentation information generation method in (13), in which a number of pieces of the data to be acquired for each category of the data is set in the comprehensive condition, and the determining involves determining a category of data for which the number of pieces of data is insufficient.

(17) A presentation information generation method according to one exemplary embodiment of the present disclosure is the presentation information generation method in (13), in which the determining involves determining data among insufficient pieces of the data which is a prioritized acquisition target, and the generating the presentation information involves generating the presentation information from the data being the prioritized acquisition target.

(18) A presentation information generation method according to one exemplary embodiment of the present disclosure is the presentation information generation method in (13), in which information that indicates a difference in an action for transition from a current state to a state of an insufficient piece of the data is generated as the presentation information.

(19) A presentation information generation method according to one exemplary embodiment of the present disclosure is the presentation information generation method in (13), in which a video or still image that shows transition from a current state to a state of an insufficient piece of the data is generated as the presentation information.

(20) A presentation information generation method according to one exemplary embodiment of the present disclosure is the presentation information generation method in (15), in which information including the metadata is generated as the presentation information.

While various embodiments have been described herein above, it is to be appreciated that various changes in form and detail may be made without departing from the spirit and scope of the disclosure(s) presently or hereafter claimed.

### INDUSTRIAL APPLICABILITY

The present disclosure is available for use in a presentation information generation apparatus and a presentation information generation method.

### REFERENCE SIGNS LIST

10 Sensor
20 Acquired data storage
30 Comprehensive condition storage
40 Data collection processor
41 Data acquiring circuitry
42 Data acquisition status determining circuitry
43 Similarity calculating circuitry
44 Presentation information generating circuitry
45 Acquisition status absolute-quantity determining circuitry
46 Relative information generating circuitry
47 Animation generating circuitry
48 Comprehensive condition dynamic controlling circuitry
49 Variable-instruction instructing circuitry
50 Presenter
51 Display
52 Speaker
60 User

1. A presentation information generation apparatus, comprising:
a data acquiring circuitry which, in operation, acquires data from a sensor;
a determining circuitry which, in operation, determines an acquisition status of acquisition target data based on a comprehensive condition and the data acquired, the comprehensive condition being a condition related to the acquisition target data; and
an information generating circuitry which, in operation, generates presentation information corresponding to insufficient data among pieces of the acquisition target data for which the acquisition status is inadequate.

2. The presentation information generation apparatus according to claim 1, further comprising:
a similarity calculating circuitry which, in operation, determines whether the acquired data and the insufficient data are similar to each other, wherein
the information generating circuitry generates the presentation information when the acquired data and the insufficient data are similar to each other.

3. The presentation information generation apparatus according to claim 1, wherein
the data acquiring circuitry generates metadata that includes information on a feature quantity of the acquired data and associates the metadata with the acquired data.

4. The presentation information generation apparatus according to claim 1, wherein:
the comprehensive condition includes a category for classifying the acquisition target data and an acquisition target number for each category, and
the determining circuitry determines, as the insufficient data, a category for which the acquisition target number is not reached.

5. The presentation information generation apparatus according to claim 1, wherein:
the determining circuitry determines prioritized data, which is a target for prioritized acquisition, from among pieces of the insufficient data, and
the information generating circuitry preferentially generates the presentation information for the prioritized data.

6. The presentation information generation apparatus according to claim 1, wherein
the information generating circuitry generates, as the presentation information, information indicating an action for transition from the acquired data to the insufficient data.

7. The presentation information generation apparatus according to claim 1, wherein:
the acquired data is an image, and
the information generating circuitry generates, as the presentation information, a video or still image showing transition from the acquired data to the insufficient data.

8. The presentation information generation apparatus according to claim 3, wherein
the information generating circuitry generates, as the presentation information, information including the metadata.

9. The presentation information generation apparatus according to claim 1, wherein
the information generating circuitry further generates the presentation information corresponding to sufficient data among the pieces of acquisition target data for which the acquisition status is adequate.

10. The presentation information generation apparatus according to claim 1, wherein
the information generating circuitry generates, as the presentation information, information including audio information.

11. The presentation information generation apparatus according to claim 1, further comprising:
a controlling circuitry which, in operation, changes the comprehensive condition based on the acquired data.

12. The presentation information generation apparatus according to claim 1, wherein
the information generating circuitry generates, as the presentation information, information for which a presentation mode differs depending on a content to be presented.

13. A presentation information generation method, comprising:
acquiring data from a sensor;
determining insufficient data among pieces of acquisition target data based on the data acquired and a comprehensive condition in which the pieces of acquisition target data are set, the insufficient data not satisfying the comprehensive condition; and
generating presentation information corresponding to the insufficient data.

14. The presentation information generation method according to claim 13, further comprising:
generating the presentation information when the acquired data and the insufficient data are similar to each other.

15. The presentation information generation method according to claim 13, further comprising:
generating, based on the acquired data, metadata that includes information on a feature quantity of the acquired data and storing the metadata in a storage in association with the acquired data.

16. The presentation information generation method according to claim 13, wherein
a number of pieces of the data to be acquired for each category of the data is set in the comprehensive condition, and the determining involves determining a category of data for which the number of pieces of data is insufficient.

17. The presentation information generation method according to claim 13, wherein
the determining involves determining data among insufficient pieces of the data which is a prioritized acquisition target, and the generating the presentation information involves generating the presentation information from the data being the prioritized acquisition target.

18. The presentation information generation method according to claim 13, wherein
information that indicates a difference in an action for transition from a current state to a state of an insufficient piece of the data is generated as the presentation information.

19. The presentation information generation method according to claim 13, wherein
a video or still image that shows transition from a current state to a state of an insufficient piece of the data is generated as the presentation information.

20. The presentation information generation method according to claim 15, wherein
information including the metadata is generated as the presentation information.
